(19) United States
(12) Patent Application Publication
(10) Pub. No.: US 2015/0164088 A1
(43) Pub. Date: Jun. 18, 2015

(54) APPARATUS FOR BAKING PANCAKES

(71) Applicants: Sergey Victorovich Polashaev, Moscow (RU); Petr Vladimirovich Mochalov, Moscow (RU); Pavel Sergeevich Milyk, Moscow (RU)

(72) Inventors: Sergey Victorovich Polashaev, Moscow (RU); Petr Vladimirovich Mochalov, Moscow (RU); Pavel Sergeevich Milyk, Moscow (RU)

(73) Assignee: ALMERICK HOLDINGS LIMITED, Nicosia (CY)

(21) Appl. No.: 14/629,598

(22) Filed: Feb. 24, 2015

Related U.S. Application Data
(63) Continuation of application No. PCT/RU2013/000408, filed on May 20, 2013.

(30) Foreign Application Priority Data
Jul. 13, 2012 (RU) 2012129533

(51) Int. Cl. A21B 5/03; A21D 13/00

(52) U.S. Cl. CPC A21B 5/03; A21D 13/0077

(57) ABSTRACT

The present invention is a pancake making machine having a frame which provides structure to the invention. Within the frame is a stationary plate, and a mobile section plate. A turnover device allows transfer of the pancake from the stationary plate to the mobile section plate. On a front portion of the mobile section plate is a filling device configured to fill the pancakes with filler stuff, while the end part of the mobile section plate forms a curvilinear area to roll the filled pancakes and to discharge them onto a collection tray.

### BACKGROUND

1. Field of the Invention

The utility model described herein relates to the food industry, namely to the equipment for cooking food items, generally, pancakes made of liquid batter.

2. Description of Related Art

Known device consists of a supporting frame, a dosing device, a belt conveyor with bakery molds and an oven, wherein the belt conveyor is placed inside the oven and the bakery molds are mounted on a module consisting of a die set, while the dosing device is connected with the belt conveyor via a belt position sensor.

Limited functionality is considered the main drawback of this device.

Also another device is known consisting of a frame, upper and lower soles with heating elements mounted in it, and temperature control sensors, while the upper sole can move along the frame until it takes its operating position above the lower sole.

Limited functionality is also considered the main drawback of this device.

The closest, in terms of technical essence, to the present invention is a machine for baking individual items, mainly, pancakes, which includes a carcass, a batter hopper, a dosing mechanism, a batter feeder, pans for initial and final frying equipped with heating elements, a collection tray for baked items, and a driving mechanism, whereas the frying pans being mounted on the carcass capable of moving in such a way that the upended initial frying pan may be positioned right above the final frying pan, which, in its turn, may be positioned above the collection tray, while the drive that actuates all mechanisms is made as a gear-train consisting of one central drive shaft with a segment gear mounted on it, two intermediate shafts with gears and gear segments, four driven shafts with gears mounted on it, whereas all shafts have parallel axes, the gear segments can engage with the relative gears, and the number of segments' teeth equal to that of the gears and the segment-to-gear ratio is equal 0.5.

The downside to this embodiment is a limited functionality since it does not provide for filling and rolling the pancakes.

The problem can be solved through enhancement of the machine's functionality.

The desirable technical result may be achieved through development of a machine which, due to its enhanced equipment, has higher functionality, providing, for instance, not only frying pancakes on both sides but also automatically filling and rolling them.

### SUMMARY

The desirable technical result is achieved in that a machine consisting of a frame with initial and final frying pans installed respectively and equipped with heating elements, as well as an electric drive, wherein the initial frying pan is made as a stationary plate, incorporates a turnover device and a filling device, wherein the final frying pan is made as a mobile section plate, and the turnover device is installed on the frame between the stationary and mobile plates and includes the shaft of the first motor with movable thin-plates accomplished so that they can be placed, if empty, over the stationary plate, and if having the baked batter on them—turning the batter over onto the mobile section plate where in its front part a filling device is installed to fill the pancakes with the filler stuff by portions, while the end part of the section plate is mounted on the shaft of the second motor forming a curvilinear area to roll the baked and filled pancakes and discharge them onto the collection tray.

### DRAWINGS DESCRIPTION

FIG. 1—pancake making machine, side view.

FIG. 2—pancake making machine, top view

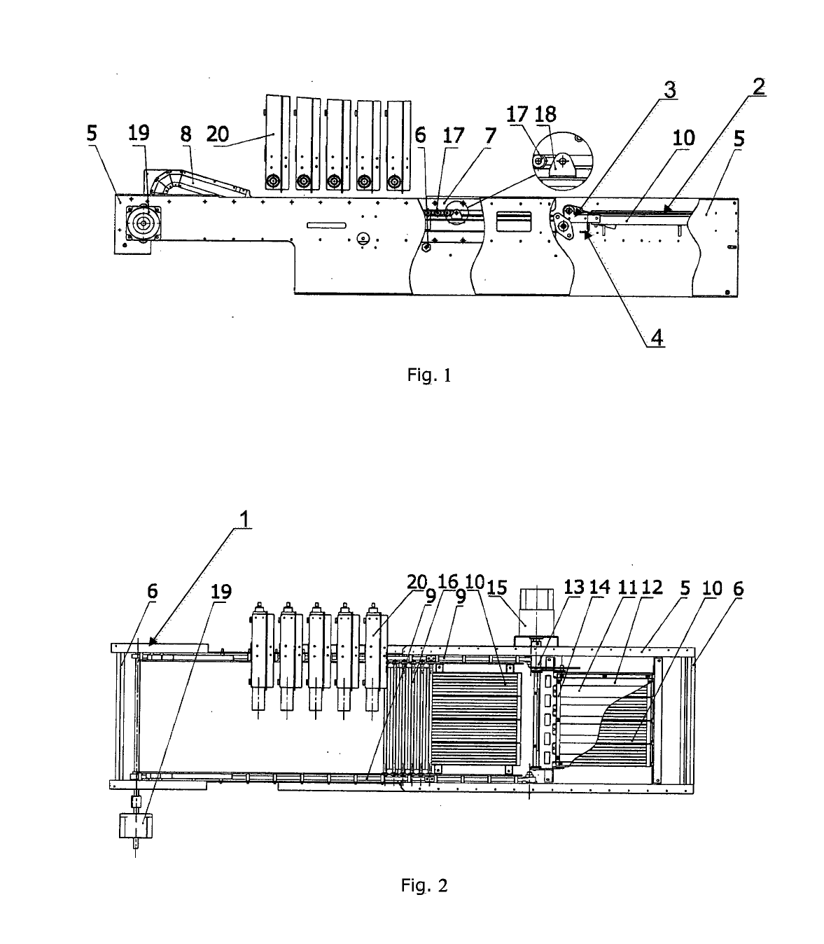

### EMBODIMENTS

The pancakes making machine includes a supporting frame 1, a stationary plate 2, a turnover device 3 and a mobile section plate 4. The supporting frame 1 includes supporting walls 5, cross beams 6, section plate guide rails 7, curvilinear areas 8 for pancakes rolling, cogged belt 9, as well as the heating elements units 10 mounted on the supporting frame.

The stationary plate 2 consists of stationary thin plates 11, while the turnover device 3 includes mobile thin plates 12 mounted on shaft 13 of the first electric motor 15 by means of the retaining thin-plate 14.

The mobile section plate 4 incorporates thin-plates 16 of the mobile section plate, rollers 17 and actuator arms 18.

The mobile section plate 4 is operated through the second electric motor 19.

Furthermore, the frame 1 of the pancake making machine incorporates a filling device 20 to fill the pancakes with a filler.

The pancake making machine includes installed one by one on the frame 1 a stationary plate 2 which serves as a pan for initial frying and a mobile section plate 4 which serves as a final frying pan. The frame 1 includes a heating elements unit 10 which provides pancakes frying on the stationary plate 2 and on the mobile section plate 4.

Further, a turnover device 3 mounted on the frame 1 on the first motor's shaft 15 is provided between the mobile section plate 4 and the stationary plate 2. The turnover device 3 incorporates movable thin-plates 12 which, when empty, can be overlaid on the stationary plate 2.

If the pancakes fried on top side are placed on the movable thin-plates 12 they can be overturned onto the mobile section plate 4. A filling device 20 to fill the pancakes is installed in the front part of the section plate 4 on the frame 1. The filling device 20 provides placing the filler on the pancake which earlier has been fried from both sides.

The rear part of the mobile section plate 4 is accomplished on the shaft of the second motor 19 forming a curvilinear area to roll the fried and filled pancake and discharge it onto the collection tray.

The supporting frame 1 is a structure wherein the heating elements units 10 are mounted. The frame structure is made of two parallel supporting walls 5 connected with cross beams 6. Each supporting wall 5 incorporates on its interior surface the guide rails 7 for movement of the mobile section plate, wherein the guide rails transform into the curvilinear areas 8.

The stationary plate 2 includes several thin-plates 11 covered with a non-stick coating and equally spaced and located above the heating elements unit 10. Between the stationary thin-plates 11 the mobile thin-plates 12 are inserted with a minimal gap and rotate around the shaft axis of the first motor 15.

Due to the rotation of the mobile thin-plates 12 the pancake is placed with its face surface on the mobile section plate 4.

The mobile section plate 4 represents a set of thin-plates 16 with a flexible connection. The end parts of the thin-plates 16 of the mobile section plate include rollers 17 designed to provide free movement of the thin-plates 16 along the guide rails 7 of the supporting frame 1.

The mobile section plate 4 is operated via the arm 18, one end of which is secured on the mobile section plate 4 and the other end is rigidly fixed with the cogged belt 9 (also a chain, a V-belt, a multi-ribbed belt or a flat belt and etc. may be used).

The cogged belt 9 is actuated via a rotation source, in particular, via the shaft of the second motor 19 (a pneumatic or hydraulic motor and etc. may be used).

The pancake making machine operates as follows. The machine itself is a unit of the automatic pancake making line. The machine is designed for baking the pancakes and turning them over for frying on both sides, and then rolling after the pancakes have been filled.

The batter is poured from the feeder (not shown in the drawings) onto the stationary plate which is heated via heating elements 10 where the stationary thin-plates 12 of the turnover device 3 have been placed in advance.

After initial frying the pancake via the turnover device 3 is placed with its top surface down onto the mobile section plate 4, which has been heated earlier by the heating elements 10. After the required holding of the baked batter, a filler is applied on the pancake from the filling device 20 and the pancake is then transported by the guide rails 7 to the curvilinear area 8 where it is rolled and, when the mobile section plate 4 moves to its end position, the filled and rolled pancake is discharged due to the gravity force from the plate 4.

Thus, due to the equipment enhancement in the suggested embodiment the desired technical result featuring an extended functionality is achieved. Notably, the machine provides not only double-side frying of pancakes but also their automatic filling and rolling.

In one embodiment, the present invention comprises a pancake making machine comprising a frame with initial and final frying pans installed respectively and fitted with heating elements, as well as an electric drive, wherein the initial frying pan is made as a stationary plate, and featuring a turnover device and a filling device, wherein the final frying pan is made as a mobile section plate, the turnover device is installed on the frame between the stationary and mobile plates and includes the shaft of the first motor on which the movable thin-plates are accomplished so that they can be placed, if empty, over the stationary plate, and if having the baked batter on them—placing the batter onto the mobile section plate where in its front part a filling device is installed to fill the pancakes with the filler stuff by portions, while the end part of the section plate is mounted on the shaft of the second motor forming a curvilinear area to roll the filled pancakes and discharge them onto the collection tray.

Speaking generally, and for the purposes of summarizing, the present invention is a pancake making machine comprising a frame with initial and final frying pans installed respectively and fitted with heating elements, as well as an electric drive, wherein the initial frying pan is made as a stationary plate, and featuring a turnover device and a filling device, wherein the final frying pan is made as a mobile section plate, the turnover device is installed on the frame between the stationary and mobile plates and includes the shaft of the first motor on which the movable thin-plates are accomplished so that they can be placed, if empty, over the stationary plate, and if having the baked batter on them—placing the batter onto the mobile section plate where in its front part a filling device is installed to fill the pancakes with the filler by portions, while the end part of the section plate is mounted on the shaft of the second motor forming a curvilinear area to roll the filled pancakes and discharge them onto the collection tray for finished products

1. (canceled)

2. A pancake making machine comprising:
a frame;
a first frying pan within the frame, the first frying pan being formed as a stationary plate;
a second frying pan within the frame, the second frying pan being formed as a moveable plate;
a turnover device between the first and second frying pan, the turnover device comprising a shaft, and a plurality of thin plates, the plurality of thin plates being positioned over the first frying pan in a first position, and movable to a second position about the shaft, away from the first frying pan, the second position configured to flip a quantity of cooked batter onto the second frying pan;
a filling device positioned adjacent to the second frying pan, the filling device configured to provide a filling within the quantity of cooked batter while on the second frying pan;
wherein an end portion of the second frying pan movable plate is mounted on a shaft of a second motor, forming a curvilinear area configured to roll the quantity of cooked batter; and
a collection tray positioned adjacent to the second frying pan, the collection tray configured to receive a rolled quantity of cooked batter discharged from the second frying pan.

3. The machine of claim 2 further comprising a heating element positioned in communication with the first frying pan.

4. The machine of claim 3 further comprising the heating element positioned in communication with the second frying pan.

5. The machine of claim 2 wherein each of the plurality of thin plates of the turnover device comprise a non-stick coating.

6. The machine of claim 2 further comprising a batter feeder configured to dispense the quantity of batter onto the first frying pan.

7. The machine of claim 2 wherein the filling device comprises a plurality of injectors.

8. The machine of claim 2 wherein the second frying pan movable plate is movable via a belt from a first position configured to receive the quantity of cooked batter from the first frying pan, to a second position forming the curvilinear area.

9. A method of making a rolled and filled pancake using the pancake making machine of claim 2 comprising the steps of:
dispensing a quantity of batter onto the first frying pan;
cooking a first side of the quantity of batter on the first frying pan;
flipping the quantity of batter having the cooked first side using the turnover device onto the second frying pan;
cooking a second side of the quantity of batter, forming a pancake;
filling the pancake using the filling device;
rolling the pancake on the curvilinear area of the movable plate; and
discharging the rolled pancake into the collection tray.
